(19) United States
(12) Patent Application Publication
(10) Pub. No.: US 2006/0055131 A1
(43) Pub. Date: Mar. 16, 2006

(54) Transportable bicycle comprising a dismantlable-frame and reduced-size pedals and handlebars

(76) Inventor: Patrice Elfandi, Paris (FR)

Correspondence Address: Patrice Elfandi, 42 Rue Du Four, Paris, 75006, FR

(21) Appl. No.: 10/544,142

(22) PCT Filed: Jan. 8, 2004
(86) PCT No.: PCT/FR04/00021

§ 371 Date: Oct. 11, 2005

(30) Foreign Application Priority Data
Jan. 13, 2003 (FR) 03/00279

(51) Int. Cl. B60N 2/427

(52) U.S. Cl. 280/29

(57) ABSTRACT

The invention relates to a traditional bicycle which can be easily transported in a car owing to the following components, namely a frame comprising (i) a section (3,4) connector system which is equipped with a fitting having an axial bore for the movement of an automatic bolt and (i) a device (13); for connecting the brake and chainwheel cables, such that the frame can be disassembled and reassembled in an instant; a handlebar stem (46) which can be oriented by manoeuvring a lever in order immediately to position the handlebar parallel to the front wheel, such that said handlebar has a minimum amount of clearance; and pedals (77) which can be quickly folded down against the cranks of the crankset, such that said pedals have the minimum clearance width.

The invention relates to a standard bicycle which may be disassembled into restricted clearance parts, that makes transportation easy owing to a handlebar stem which enables the handlebar to position parallel to the front wheel, and pedals with restricted clearance.

Such a detachable bicycle with said handlebar stem and said pedals is known in particular in the document Patrice ELFANDI WO 02-47963 A1 which states:

Male female connector systems at the frame sections level are mounted on the tubes, one of them is a hollow tube, the other one have a mobile male nozzle or a bolt whose diameter is slightly lower than the tubes one in order to fit into them. The mobile nozzle or the bolt is equipped with an original jamming device: on the method with a male nozzle for one beam bicycles, the traction of the nozzle top end compresses an elastic ring against its root; on the method with a lock bolt for the two tubes bicycles, the bolt has several parts which compress together (the) elastic(s) ring(s) when the top end bumps against the female part bottom. The connectors are sometimes equipped with some switch cable devices which enables putting on/off the brake switch and chain wheel cables continuity, each device comprises a fixed structure straddling the tube section two parts; two mobile structures located on either side of the section, moving on said fixed structure; retaining means which keep the mobile structures near of the section, a driving mean which joins together both mobile structures.

A handlebar stem (excluding from the patent the handlebar horizontal part) which comprises a lower part extended by a binding rod to the fork, said rod base lies on a central relief, and an upper part arranged to engage with said rod.

An original pedal equipped of a pedal sole whose bars slide in the style of a drawer on the axles; the pedal sole moving shows the joints and enables to fold down the sole against the crank of the crank set.

Such a known connector system of a disassembled frame has the disadvantage that in reason of the diameters and section shapes multiplicity, many tubes sizes and models are necessary. Besides, the bolt in several parts on two tubes bicycles has the disadvantage that the compression of the elastic ring(s) by the bolt end when bumping against the female part bottom, tends to move it away from the male part instead of keep them joined, furthermore, the lock bolt is more expansive and difficult to mount in the tube because of the tube frame low diameter.

Such a known cable switch device has the disadvantage that retaining and driving means are facing together under the action of antagonist springs, it requires preciseness to position it and it is expansive, besides the cylindrical part on which lies the bridge is voluminous, inesthetic and makes difficult to set two cables on the same tube.

Such known handlebar stem in which a wheel connects both the stem two parts together has the disadvantage that the threaded rod protrudes over the top of the stem and may hurt the user.

Such a known pedal has the disadvantage not to have a stop to limit the pedal sole running which may go out of the axles, besides on the pedal with only one ball bearing, the press studs each provided with a spring and the sole bound by hooks which penetrate into openings provided on the axle are fragile and expansive to make. Finally on the traditional pedal with two ball bearings, the central steel axle shown in one piece without any joint, has the disadvantage to have a large clearance and to prevent the sole fastening on the steel framework by a screw described and shown in the one ball bearing pedal.

The aim of this invention is to compensate for the disadvantages and to improve the anterior technology, more specifically to propose a bicycle instantaneously detachable with male-female connector systems as mentioned in the introduction which will be standard adaptable to all tubes diameters and section shapes, this invention states also a bolt which gets automatically into the female part without any external operation and advantageously substitute for the lock bolt because of the crampness of the tubes and because it is cheap, Furthermore, in the two tubes bicycles, the elastic ring(s) deformation is not the consequence of a pressure but of an attraction of said bolt end by the rod towards the root.

This invention states also a switch device for the brake and chain wheel cables as mentioned in the introduction in which retaining means are not facing the driving means; their restricted clearance enable to set several cables in parallel on the same tube, said device is easy to use and cheap.

This invention states also a handlebar stem as mentioned in the introduction in which fastening both the two parts together is easy, quick and without any danger for the user.

This invention states finally a pedal as mentioned in the introduction in which the sole cannot go out of the axles on which it slides; the sole is equipped with a simple and cheap fastening mean.

The connector device of the detachable bicycle two parts according to the invention is original and as per one feature a piece is mounted in the tubes near to the section, this piece is solid made of metal or synthetic material, fitted to the tubes diameter and shape at the tube section, it is mounted by any fastening mean (screwing, setting, riveting . . . ), said piece is also remarkable by a circular cavity directed axially or parallel to the tubes axle in order to receive any connector system components. Furthermore, in the two tubes bicycle the connector system may have an automatic bolt which gets automatically into the female part, its root is interdependent of a framework, this one slides in the tube or in the axial cavity under the action of a spring jammed on a fixed structure (either the partition set in the tubehollow, or the bottom of the female part), said root has a central conduit in which slides an axle holding the bolt top end linked to a cam lever; the top end is attracted towards the root deforming the elastic ring(s).

The switch cable device of the detachable bicycle according to the invention is remarkable because the fixed structure front part is surrounded with a fixed tube in which slides the mobile structure comprising two parts: the front part connected with the command cable (brake lever), is provided with a spring which keep constantly the front mobile structure in contact with the section and take the place of a retaining mean.

According to another feature of the invention, said front mobile structure back end (or the end of the cable), has a mushroom shaped piece comprising a narrow part (or neck) and a head (or a ball) with a large diameter which projects into the section, a weakly force may move the mobile structure forwards.

According to another feature of the invention, the back mobile structure back end has a transversal cylinder which touches the section, said cylinder is mobile with the back structure which holds it, and the cylinder may turn around a transversal axle on ¼ or ⅓ of circumference. Said back mobile structure back end is connected with the brake or chain wheel cable, it is the back mobile structure retaining mean backwards.

According to another feature of the invention a cylindrical structure portion has a circular hole with a large diameter extended by a linear slot on an arc of said surface in a plane parallel to the bases of said cylinder at equal distance of these bases.

According to another feature of the invention, said circular hole of said cylindrical surface as a slightly larger diameter than the piece head one held by the front mobile structure, it communicates with a cavity into said cylinder, this cavity may receive said head; said cylinder cylindrical surface linear slot has a slightly larger width than the one of said piece neck.

According to another feature of the invention, the driving mean of said back fixed structure back part has a top limit which may be the fixed tube bottom, it is the retaining mean backwards of the mobile structure.

According to an another feature of the invention, said piece and said cylinder are the front and back mobile parts driving means when they came in contact at the section level: said piece head of the front structure tends to continuously occupy the cylinder intern cavity through said circular hole. The rotation of the cylinder with a side driving lever (set on one base of the cylinder) inserts said front mobile structure piece neck into said linear slot of the cylindrical surface, this position take prisoner the head in the cavity of the cylinder connecting both the front and the back mobile structures together, putting on the cable continuity and allows the transmition of the movement. The inverse operation allows the separation of the mobile structures putting off the cable continuity and to disassemble the frame into two parts. Accordingly some safety procedures allows to firmly jam the cylinder driving levers on the positioned cable connected or disconnected. The restricted clearance of this switch cable device enables to set several devices in parallel, for instance two switch devices in which the mobile structures axles are in line, the levers of each one are facing at each other on the mobile structures interval of separating both sides, thanks to this configuration the levers may be disconnected, constantly letting mobile and independent the mobile structures from the fixed ones, they both pivot together and simultaneously put off or on the cables (brake and chain wheel) continuity with an only maneuvering.

The handlebar stem according to the invention is remarkable because the hollow of its upper part comprises two solid parts delimiting a space between them and both provided with a central conduit, the solid upper part has a cylindrical shape and may slide and pivot in the hollow of the tube upper part and through the central conduit on the rod, for fastening to the fork extending up above the lower stem tube; the upper part of said rod protrudes from the solid upper part conduit and is linked with a cam lever. At the upper part hollow level, the rod lower part has a widening of its diameter or a sewed piece in shape of cylinder, interdependent of the rod, so fixed; the high part of said rod has a solid cylinder interdependent with the upper part and provided with a central conduit, forming with the upper part a unity which may move on the rod; The rod middle part is occupied by a large soft elastic ring set between the upper and the lower cylinders. The cam lever linked to the rod upper part pushes down the unity with the upper cylinder which slides on the rod and get closer to the fixed lower cylinder, deforming the elastic ring jamming all stem upper part vertical movement, advantageously the upper part hollow may be provided with slightly tighter section zones in order to perfect the jamming like the linking of both the two stems parts together.

The pedal with a mobile sole on two axles according to another feature of the invention is remarkable because a portion of the folding steel axles each end has a notch which corresponds to an arc of circle of its section which rope is facing a rod plane surface going through the steel tube sliding on the axle, on this tube is molded the sole bar, this rod is a stop for limit the running of the tubes and prevent the sole to separate from the axles.

The conventional two ball bearings pedal according to another feature of the invention is remarkable because the central axle is provided with a joint, the axle of which is in line with the steel axles ones on which slides the sole; the end of the central axle has a pitch screw on which is screwed a framework holding the ball bearings interdependent of the sole which slides on the axle. In another making method, the central axle may also comprise two parts: a short part in the continuation of the fastening thread to the crank has an hollowed axle which forms a female site, its root near to the internal ball bearing may be threaded on its out cylindrical surface; a long part which may inserts into the said female site, this part end holds a ball bearing on which turns the pedal sole. A threaded ring adjoining to the long part enables either to screw it on the threaded root, uniting both the central axle two parts together, so indirectly the sole with the steel framework, or to untie it allowing to move and to pull down the sole.

According to another making method of the traditional pedal with two ball bearings, the pedal central axle said short part root instead to be threaded, has vertical curved grooves which cuts across its section, said pedal axle long part end has a lever with a cylindrical surface; a portion of this cylinder pivots on a transversal axle and has a circular hole which diameter is slightly larger than the central pedal axle short part one, this hole is extended by a linear slot narrower, but slightly larger than the space which separate the grooves of said central axle short part when moving closer both pedal axle long and short parts together, the short part end penetrates into said lever circular hole, the rotation of the lever engages the slots into the curved grooves and unites both the axle two parts, so the sole and the framework together. Advantageously the lever will be provided with two fingers which will grip the pedal axle jamming the lever.

According to another making method of the traditional pedal with two ball bearings, the central axle short part root is equipped of press studs provided with hemispherical screw heads diametrically opposed the one at each other. The pressure in the same time of the two heads both between thumb and forefinger or with a pointed stool let go the long part from the short one and allows the sole to slide and pull down.

In order that other features aims and advantage of this invention may be more readily understood by reading of the description of various means of making, reference will now be made to the accompanying drawings and description of which is set out as follows:

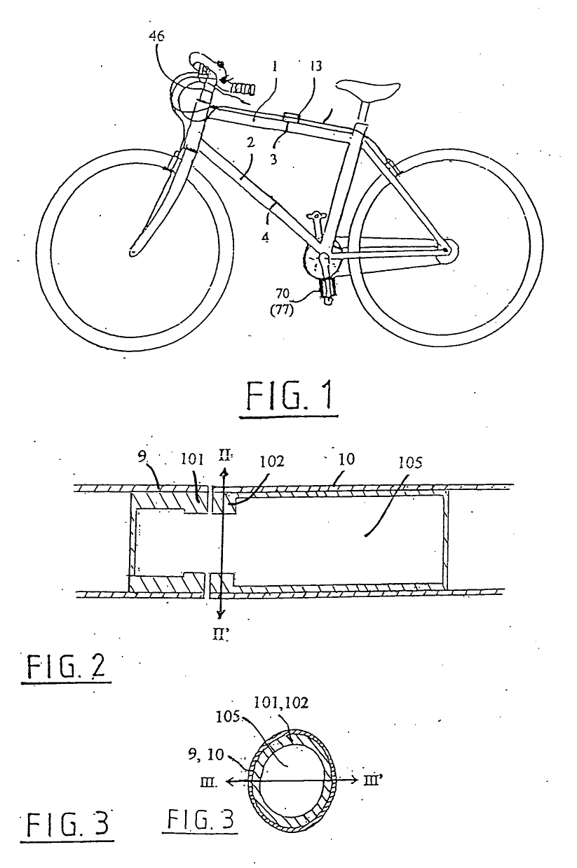

FIG. 1 is a view of a bicycle which may be disassembled in two parts, which stem allows to orient the handlebar, and pull down pedals.

FIG. 2 is a general length elevated view of the fitting piece mounted in the hollow tubes at the section level.

FIG. 3 is a sectional view according to the line II-II′ of the FIG. 2 at the piece level.

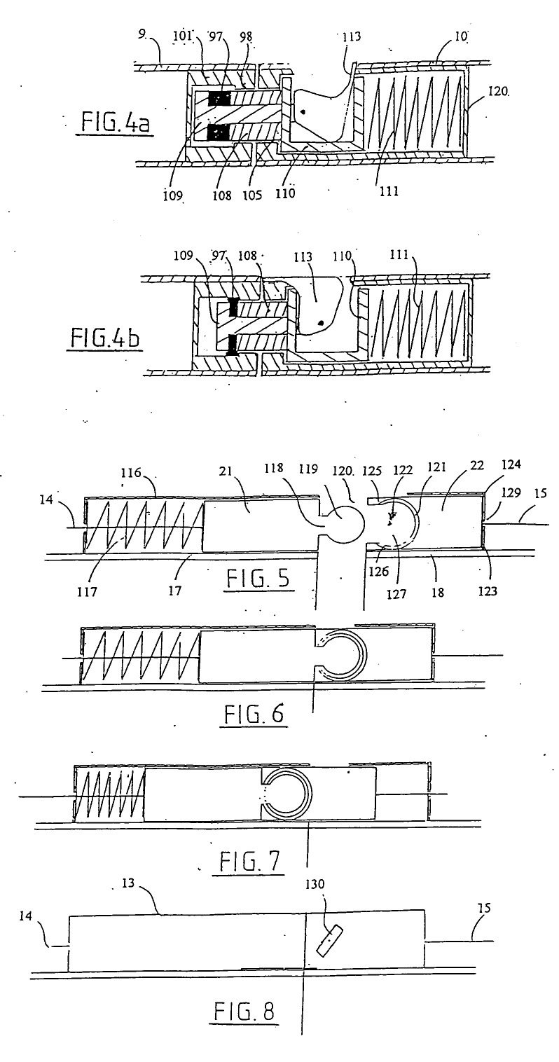

FIGS. 4a, 4b are length views from the top, according III-III′ of FIGS. 2 and 3 of a connector device and a cam lever, notably for an only one beam bicycle. FIG. 4a: male-female connector in unlocking position, FIG. 4b: in locking position.

FIG. 5 is a length elevated view of a switch cable device (disconnecting position).

FIG. 6 is a length elevated view of a switch cable device (connecting position).

FIG. 7 is a length elevated view of a switch cable device when using (either raking or changing of gear).

FIG. 8 is a lateral view of the switch cable device.

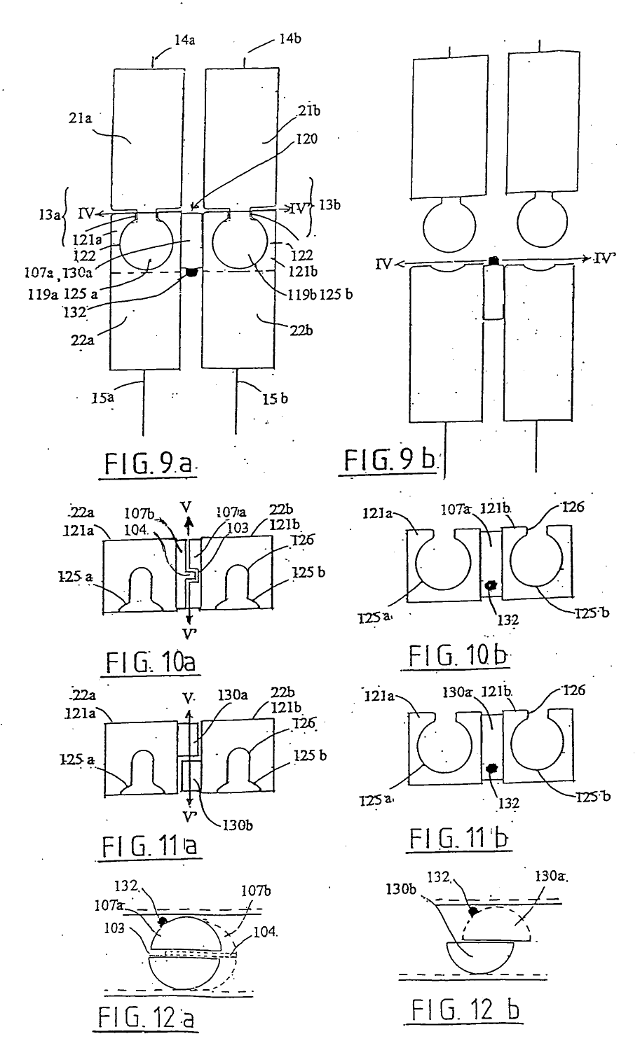

FIGS. 9a, 9b are views from the top of a switch cable device with two twin's cables.

FIG. 9a: put on, FIG. 9b: putt off.

FIGS. 10a, 10b are the back part of the switch device 9a, 9b equipped of levers with grooves, and a sectional view from the separating space according IV-IV′.

FIGS. 11a, 11b are the back part of the switch device 9a, 9b provided with half cylindrical levers.

FIGS. 12a, 12b are sections of the separation space according V-V′ of FIG. 10a.

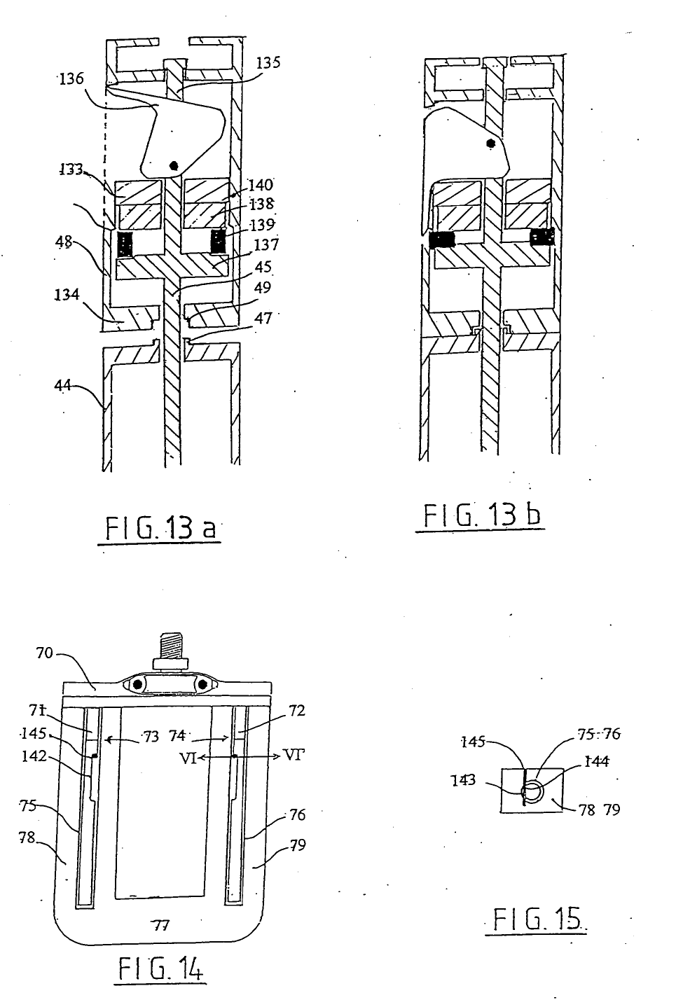

FIGS. 13a, 13b are elevated length sections of the handlebar stem:

FIG. 13a: upper part separated from the lower one, FIG. 13b: upper part fixed to the lower one.

FIG. 14 is a length sectional view of the pedal sole bars by the folding axles.

FIG. 15 is a sectional view according VI-VI′ of FIG. 14.

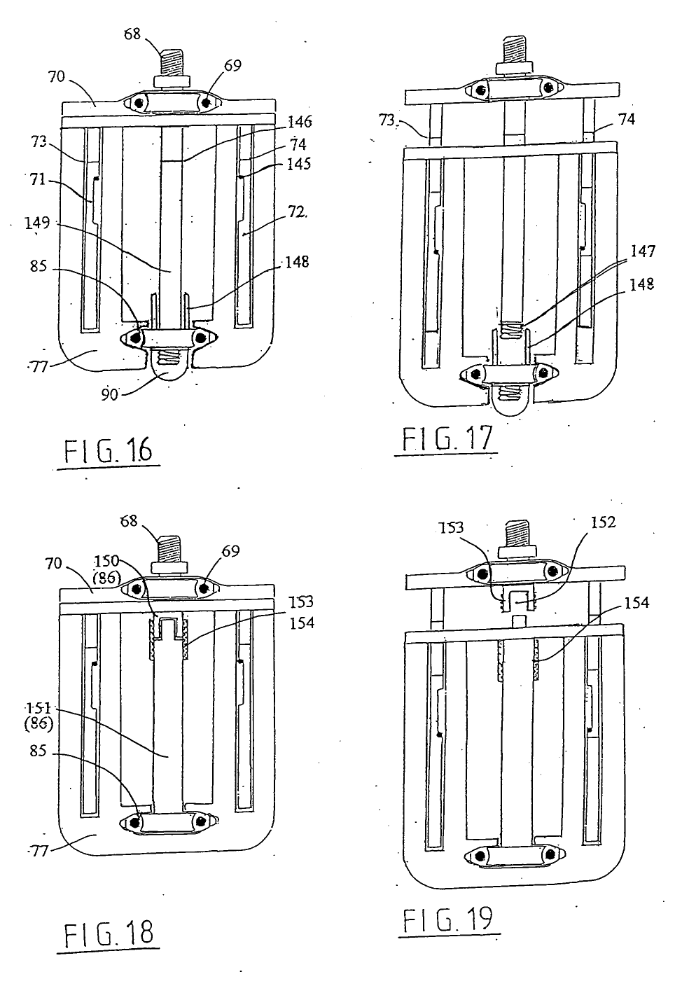

FIGS. 16, 17 are length sectional drawings of a preferred method of making of a traditional pedal sole with two ball bearings, a folding central axle and screwing fastening to the ball bearing holding framework.

FIG. 16: sole fixed to he framework, FIG. 17 sole separated from the framework, ready to be pull down.

FIGS. 18, 19 are length sectional drawings of a fastening method by screwing the long part of the central axle on the stump.

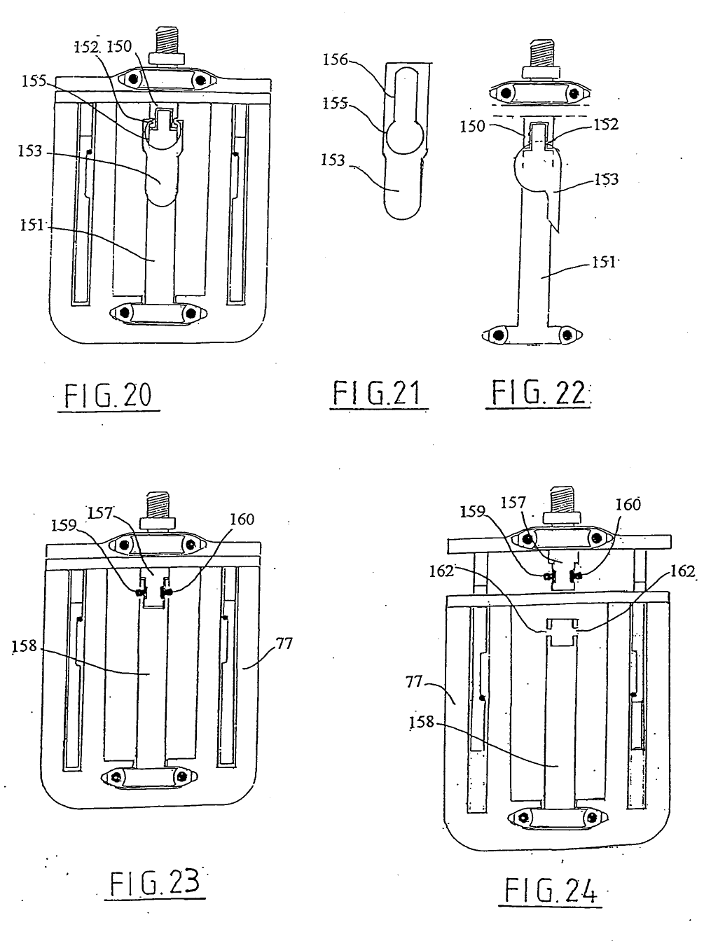

FIGS. 20, 21 are drawings of the pedal sole fastening by lever, with according FIG. 21a lay down view of the cylindrical surface.

FIG. 22 is a drawing of the sole fastening by lever according to the FIG. 20, elevational view of the sole central axle.

FIGS. 23, 24 are drawings of a sole fastening method by spring press studs with hemispherical heads set on the stump.

According to FIG. 1, the bicycle frame as shown is sectioned on the horizontal tube 1, and the oblique tube 2, (sections 3 and 4), it is equipped with a switch cable device 13, an original handlebar stem 46 which enables to orient the handlebar, and pedals 70, with pull down soles 77.

According to FIGS. 2 and 3 is shown a connector device which comprises a solid fitting piece 101, 102, in the hollow of both parts of the tube 9, 10, provided of an axial hollow 105, parallel to the axle, in order to receive the bolt 15.

According to FIGS. 4a, 4b is shown an automatic bolt for a two tubes bicycle frame: the bolt root 108 slides in the axial hollow 105 and is interdependent of a framework 110, under the action of a spring 111 jammed by a fixed structure 120; the spring constantly propels the bolt 108, 109 towards the female part 101 (tube 9), maneuvering the cam lever 113 attracts the framework 110 backwards against the strength of the spring 111, and allows to separate the two parts.

According to FIGS. 5,6,7 is shown a switch cable device 13: the front mobile structure 21 slides on the fixed structure front part 17, the back mobile structure 22 slides on the back part 18 of the fixed structure, its back end bumps against the stop limit 123, which may be the fixed tube 124 back, in which the mobile structure slides, it is the retaining mean forwards; an opening 129 is provided on the back of said fixed tube 124 for the cable 15, the pressure of which is the retaining mean for the back mobile structure 22 forwards when using. The back mobile structure 22 also slides on the fixed structure front part 17.

The fixed structure is surrounded by a fixed tube 116 in which slides the mobile structure, the front and of the tube has an opening in which run across the cable 14 going towards the brake, a supple spring 117 jammed to said front end constantly pushes the mobile structure 21 towards the separating space 120. The back end of the mobile structure 21 is provided of a piece which comprises a neck with a low diameter 118 and a head with a large diameter 119 which constantly tends to project into the separating space 120 on the mobile part, under the strength of the spring.

The back mobile structure 22 back end is provided of a transversal cylinder 121 which pivots on its own axle 122, its cylindrical surface has a circular hole 125, slightly larger than the head 119 of the piece diameter held by the front mobile structure, this hole communicates with a spherical cavity 127 of the cylinder; a narrow linear slot 126 slightly wider than the neck diameter 118 extends the circular hole 125.

The mobile structure back end 22 is connected to the cable 15 going to the command parts (brake, chain wheel).

A lateral lever 130 allows the rotation of the cylinder 121 around its axle 122, it engages the front mobile structure piece neck 118 into the slot 126, and takes prisoner the head in the cylinder back mobile structure spherical cavity 127, it puts on the cable continuity.

According to FIGS. 9a, 9b, 11a, 11b and 12a 12b, the levers 107a and 107b of the twins switch devices 13a, 13b, are facing at each other in the back mobile structures 22a, 22b interval of separation 120 they are flat cylinder (token) shaped, the one 107a has a groove 103, the other one 107b has a blade shaped piece 104, which may slide in said groove 103 when horizontal, it allows the cables 14a, 14b continuity (position of use: switch cable devices back mobile structures disconnected); the rotation of the driving lever 107a with the button 132 enables the other lever to turn (as a blade in a screw driver groove allows its rotation), it enables to unite both the cylinders 121a, 121b together, putting off simultaneously the parallel axles 14a, 14b. In another making method, the levers 130a, 130b are half cylinders cutted according their diameters, their axles are the same than the cylinders ones 121a, 121b; when the devices 13a 13b are keeping the cable 14a 14b continuity (position of use), the levers diameter is horizontal and normal to the cylinders axle 122; the upper lever 130 is provided with a button 132 in upper position on its half cylindrical surface, the lower lever 130b has its half cylindrical surface in lower position, the lever diameter 130a slides on the lever diameter 130b, they both rote together with the interdependent cylinders 121a 121b, the back mobile structures pieces heads 119a 119b may go in, or go out of the holes 125a 125b, it enables to putt off/on the cable continuity (disconnecting or connecting position).

According to FIGS. 13a, 13b, the upper part hole of the stem 48 has a solid upper part 133, a solid lower part 134 (of which central design 49 is fitting in a hollow one 49 of the stem lower part 44). The solid upper part 133 slides in the upper part hollow tube of the stem 48 and by its central slots on the fastening rod of the fork 45 which extends up above the lower part of the stem 44, its end 135 protrudes from the lower part 133 and is linked with a cam lever 136. Between both solid parts 133 and 134, the rod lower part 45 has a portion of wide diameter or is provided with a sewed piece forming a cylinder 137 interdependent of the rod, on which the tube 48 may move, the rod upper part 45 has also a cylinder 138 forming both a mobile unity which slide in the tube 48, and by its central slot on the rod 45. An elastic ring 139 occupies the space between the cylinders 137 and 138. Its then easily understood that maneuvering the cam lever 136 push down the mobile unity formed by the cylinders 133,138 towards the fixed cylinder 137 and deform the elastic ring 139 which firmly jams the stem upper part 48 and the rod 45 together, above the expanding zone of the elastic ring 139 a tighter section zone 140 is intended for the jamming ring 139.

According to FIGS. 14 and 15 the pedal sole 77 fronts and back bars 78, 79 are molded on tubes 75, 76 which slide on two folding steel axles 71, 72. A part 142 of each steel axle is notched on a portion of the arc of circle 143 of its section, which rope 144 is facing the rod 145 going through the tube 75 (or 76) and form a limit stop; its then easily understood that the rod 145 does not allows the tubes (so the bars of the sole 77) to slide on the axles 71, 72 that in the interval of the portion 142 which correspond to the length of the running which is necessary for the sole to show the joints 73, 74 when free of the framework 70 (i.e. slightly more that the length of the closer folding axles segments).

According to FIGS. 16 and 17 is shown the preferred making method: the pedal central axle 149 has a joint 146 which axle is in line with the ones of the joints 73, 74 of the axles 71, 72, the central axle top end has a thread 147 on which is screwed a structure 148 holding a ball bearing 85 and a thread 147, this structure slides on the central axle end and is interdependent of the sole through the ball bearing: unscrewing the structure 148 with the wheel screw 90 allows to move the sole 77, to show the joints 73, 74, 146 and to pull down the sole; screwing the structure unites the ball bearing 85 and the sole 77, to the framework 70.

According to FIGS. 18, 19 the central axle 86 of the pedal comprises a short part forming a stump 150 (which extends the threaded fastening 68 to the crank arm near to the ball bearing 69) and a long part 151 ended with the ball bearing 85 on which turns the sole 77. The stump 150 is emptied on its axles forming a female site 152 in which penetrates the long part 151; the stump external surface is an anchoring point for the sole, it is provided with a thread 153 for a threaded ring 145 which unite both the two parts of the axle together and binds the sole on the framework.

According to FIGS. 20, 21 and 22 this stump 150 external cylindrical surface is provided with two vertical curved grooves 152, the upper part 151 is provided with a lever 153 with a cylindrical surface which pivots around a transversal axle. This cylindrical surface has a circular hole 155 extended by a narrower linear slot 156 which corresponds to the space between the stump curved grooves 152: The stamp 150 penetrates into the hole 155 when moving close both the two parts of the axle together, maneuvering the lever 153 engages the slot 156 into the grooves 152 and unites both the two parts of the axle together.

According to FIGS. 23 and 24 is shown another method of fastening of a traditional pedal sole with two ball bearings: the central axle of pedal stump 157 is a male site and comprises two little press studs diametrically opposed 159, 160 of which hemispherical head go out from the stump 157 external cylindrical surface under the strength of a spring, these studs co-operate with circular opening 152 set on the long female part end 158; When pressing simultaneously both the studs hemispherical heads, the openings become free, it allows the sole 77 fastening or untie.

It is also understood that various methods may be of course possible, notably the end of the cable 14 may be provided with a little terminal ball, the device of fastening the two parts of the stem handlebar may be provided with several elastic rings, the central axle of pedal short and long part may be male-female indifferently and vice versa, the fastening of the sole may be a bayonet system or all others methods than screwing the lever or the press studs described.

It is finally understood than the component parts of various devices may be done from any material, in particular synthetics, the invention is not restricted to those forms described and represented and that professional will know how to bring variations or modifications thereof in conformity with his mind.

1) Bicycle comprising a dismountable frame, a handlebar stem which permit to orient the handlebar, and pull down pedals enable to restrict the clearance and make the transportation easy in a car trunk, with notably for the two tubes frame bicycles, a connector device characterized because the bolt (108) is not directly mounted in the tubes (9, 10) hollows, but through fitting pieces (101, 102) mounted in the hollow of the frame tubes fitted in shape and diameter and both having an axial hollow (105, 106) intended for the running of an original automatic bolt: its root (108) is interdependent of a framework (110) under the strength of a spring (111) leant on a fixed structure(112); the spring (111) propels the framework (110) and constantly tends to keep the bolt (108) in the female part (110) of the fitting piece.

2) Bicycle comprising a dismountable frame, a handlebar stem which permit to orient the handlebar and pull down pedals according claim 1, the switch cable device(s) is (are) characterized because: is (their) fixed structure (17) is surrounded by a tube (116) in which slide the mobile structures (21, 22); a spring (117) leant on the tube (116) front end, and constantly pushes the front mobile structure (21) towards the mobile structures space of separating (120); the front mobile structure (21) is equipped with a fitting piece which comprises a low diameter neck (118), and a head with a larger diameter (119), which may be the end of the cable (114), ended by a metallic ball; the back fixed structure (18) limited at its back end by a limit stop (123), which may be formed by the tube (124) back end, in which slides the back mobile structure (22); the back mobile structure (22) front end is provided with a transversal cylinder (121), which pivots on its axle (122), its circular surface has a circular hole (125), extended by a narrower slot (126) which communicates with a spherical cavity (127) in the cylinder (121); a lateral lever (130) allows the cylinder (121) rotation around its axle (122) and engages the fitting piece neck (118), restoring the cable (14, 15) continuity; several switch devices may be set in parallel on the tube: for instance, if there is two twins devices (13a, 13b), their levers are facing at each other in the back mobile structures (22a, 22b), a lever (107a) is provided with a button (132) and a groove (103), according its horizontal diameter, the other lever (107b) is provided with a blade shaped piece (104) which may slide in the groove (103) when in horizontal position: the parallel back mobile structures (22a, 22b) switch devices are disconnected; the rotation of the lever (107a) with the button (132) allows to connect both the cylinders (121a, and 121b)and instantaneously to putt off/on the cables (14a, 15a, 14b, 15b). The levers which are facing at each other in the back mobile structures (22a,22b) interval of separating, may also be formed by half cylinders, the upper lever (130a) has a cylindrical surface provided with a button (132) in upper position, its diameter in horizontal position and normal to the cylinders (121a, 121b) axle (122), the lower lever (130b) is also formed by a half cylinder which the half cylindrical surface is in low position and its diameter in horizontal position; the upper lever (130a) diameter may slide on the lower lever (130b), then the two back mobile structures (22a, 22b) are independent the one from the other; the rotation of the upper lever (130a) button (132) connects it with the lower lever (130b), it allows the cylinders (121a, 121b) to pivot and simultaneously put off/on the cables (14a, 15a) and (14b, 15b).

3) Bicycle comprising a dismountable frame, a handlebar stem which permit to orient the handlebar and pull down pedals according claim 1, with a stem composed of two parts characterized because the stem (48) upper part hollow has a solid upper part (133) which is mobile in the upper part of its hollow, a solid lower part (134) interdependent of the tube; the solid upper part (133) has a central hollow which slides on the fastening rod to the fork (45) which extends up the stem (44) lower part; the rod (45) end (135) is linked with a cam lever (136), the rod (45) lower part is provided with a cylinder or a sewed piece forming a cylinder (137) mobile in the tube (48), the rod (45) upper part includes a cylinder (138) adjoining with the solid part (133) forming together a unity both sliding in the tube (48) and on the rod (45), the space of separating between the cylinders (137 and 138) is occupied by an elastic ring (139), maneuvering the cam lever (136) push the mobile unity (133, 138) towards the fixed cylinder (137) and deforms the elastic ring (139), the stem (48) upper part becomes interdependent with the rod (45), itself interdependent of the stem lower part (44), the stem (48) upper part top end has a tighter section zone (140) intended for the jamming ring (139) when being deformed.

4) Bicycle comprising a dismountable frame, a handlebar stem which permits to orient the handlebar and pull down pedals according claim 1, with pedals characterized because the folding steel axles (71, 72) on which slide the tubes (75, 76) molded in the bars (78, 79) of the sole (77) have a part (142) notched on a portion of the arc (143) of its section, the notched part (142) length corresponds to the running which is necessary for the sole (77) to show the joints (73, 74); the portion of arc of circle (153) rope (144) is facing to the rod (145) going through both bars (77,78) tubes (75, 76), forming a limit stop for the sole (77) running; in the two ball bearings pedal method, the central axle is provided with a joint (146) the axle of which is in line with the joints (73, 74) ones, the central axle of pedal (149) top end is provided with a thread (147) which corresponds with the one of a screwing device (148) which holds the ball bearing (85), and slides on the central axle of pedal end; the ball bearing (85) is interdependent of the sole (77). Screwing or unscrewing the wheel screw (90) allows to fasten the sole to the framework (70) or separate of it. The ball bearing interdependent of the sole (77) may also slide directly on the central axle end (86), it allows the sole to show the joints (73, 74,146) and pull down. Any method allows fixing the sole to the framework. Finally, the pedal central axle may be arranged in two parts, a short part or stump (150 or 157) in the extension of the thread (68) arranged for bumping the framework to the crank arm, a long part (151) extended by a ball bearing—85) on which turns around the sole; the stump has a hollow (152) on its axle which is in fact a female site in which engages the male site formed by the long part (151) end, and vice versa, the stump is a male site and the long part end a female site, the stump (150 or 157) is an anchoring point for bumping the central axle long part (151 or 58) interdependent with the sole (77), then indirectly for bumping it to the framework (70) the fastening of both the two parts of the axle together may be screwing a ring (154) interdependent of the long part on a thread (153) of the stump (150) external surface; The fastening may also take place between the pedal central axle stump (150) provided with vertical curved grooves (152) and the long part (151) provided with a lever (153), which consists of a cylindrical surface with a circular hole (155) extended by a linear slot (155). Pivoting the lever around its transversal axle respectively engages the hole and the slot into the stump (150).
Finally, the fastening may be pressing studs (159,160) the hemispherical head of which may co operate with openings (162) set on the long part (151) engaging the studs into the openings bumps the central axle long part (151) and the joining sole to the stump (157), when pressing simultaneously the studs, allows to separate the two parts.
